(19) United States
(12) Patent Application Publication
(10) Pub. No.: US 2006/0278589 A1
(43) Pub. Date: Dec. 14, 2006

(54) Method and display for selling cosmetic products

(76) Inventors: Stephanie Klein Peponis, New York, NY (US); Marsha Rochelle Udell, Harrison, NY (US); Carolyn Ann Holba, Rye, NY (US); Debbie Gartner, White Plains, NY (US); Phyllis Rabinowitz, New York, NY (US)

Correspondence Address: Julie Blackburn;Revlon Consumer Products Corporation, 237 Park Avenue, New York, NY, 10017, US

(21) Appl. No.: 11/283,239

(22) Filed: Nov. 18, 2005

Related U.S. Application Data
(60) Provisional application No. 60/688,529, filed on Jun. 8, 2005.

(51) Int. Cl. B42F 17/00

(52) U.S. Cl. 211/10

(57) ABSTRACT

A cosmetic display for eye products where at least some of the products are placed into subsections based upon eye color and the products in each subsection are color coordinated with each other; a display for lip products wherein at least some of the products are placed into subsections based upon basic shade and the products in each basic shade subsection are color coordinated with each other; a display comprising at least one section for face products where products are placed into subsections based upon the skin type for which they are suitable in combination with at least one of the eye or lip product sections; and, optionally containing additional sections with products that provide a desired end benefit; and a method for enabling the consumer to select products from the display of the invention.

### RELATED APPLICATIONS

This application claims priority from provisional patent application Ser. No. 60/688,529, filed Jun. 8, 2005.

### TECHNICAL FIELD

The invention is in the field of a method and display for selling cosmetic products in self-select distribution channels.

### BACKGROUND OF THE INVENTION

It is a common problem that consumers who shop for cosmetics are often bewildered by the wide array of products available. Selecting products suitable for their skin type, skin color, or eye color is hit or miss, and often consumers end up purchasing an array of products that may not meet their needs. This is a particular problem for cosmetics manufacturers that sell their products in what is referred to as self-select distribution channels. The term “self-select” means that the consumer selects her cosmetics by herself based upon her interpretation of what she needs or wants, and generally without support and advice of a beauty advisor. Self-select channels are most frequently seen in mass market retail outlets, food stores, or drug stores. When cosmetics are sold in prestige channels of trade (such as department store), beauty advisors are often present and provide the customer with whatever guidance and assistance is needed to make proper selections of cosmetic products, based upon skin type, skin color, and desired cosmetic effects. However, such assistance has its price, which is why cosmetics sold in prestige channels are often much more expensive than cosmetics sold in self-select channels.

Accordingly, anything that would simplify shopping for cosmetics in the self-select channel would increase sales of cosmetics in that channel by educating consumers to purchase color coordinated items that match their skin and eye tones and are generally suitable for their skin type. In addition, such a set up would also engage cross-over customers who shop in prestige channels only because of the advice and assistance of beauty advisors to also shop for cosmetics in mass market channels. There is obviously a need for a cosmetic sales and display wall that simplifies the consumer's shopping experience by providing a nearly foolproof way to select cosmetics suitable for her skin type, eye color, and lip shade preference, where the color cosmetics for her category are color coordinated or otherwise matched to skin type.

It is an object to provide a process and product that improves consumer shoppability, the consumer shopping experience, and tailoring cosmetic products to the consumer's personal and physical features.

It is a further object of the invention to provide a display and process for assisting retailers that sell cosmetic products to better identify their customers by shopping patterns. For example, when cosmetics in one section (such as display section containing products for blue eyes) deplete more rapidly than the sections containing cosmetics for other eye colors, the retailer will know that his customer base is predominantly blue eyed.

It is an object of the invention to provide a method for a consumer to select face products, eye products, lip products, or other products suitable for her skin type, coloring, and/or desired end benefit.

It is an object of the invention to provide a method for a consumer to select cosmetic products that are color coordinated and suitable for her skin type, coloring, and/or desired end benefit.

It is a further object of the invention to provide a cosmetic display to simplify the consumer's shopping experience by categorizing the products by skin type, eye color, shade of lip preference, or desired end benefit.

It is a further object of the invention to provide a method for simplifying the consumer's shopping experience by categorizing the cosmetic products based upon skin type, eye color, lip shade preference or desired end benefit.

It is a further object of the invention to enable the cosmetics shopper to purchase face, eye, or lip products that are suitable for her skin type and color-coordinated with her eye and skin color using minimal consumer interpretation, e.g. the consumer interprets simple parameters such as skin type (oily, normal/combination, or dry), eye color (green, blue, brown, or hazel), or preferred basic shade for lip products; and optionally, desired end benefit, or other suitable parameters.

### SUMMARY OF THE INVENTION

The invention is directed to a cosmetic display comprising at least one section for eye products wherein said eye products are placed into subsections based upon the eye color for which they are color coordinated.

The invention is further directed to a cosmetic display comprising at least one section for lip products wherein said lip products are placed into subsections based upon basic shade.

The invention is further directed to a cosmetic display comprising, in combination

(a) a first section containing face products wherein such face products are placed into subsections based upon the skin type for which they are most suitable, and

(b) at least one of an additional section, wherein said additional section is selected from:

(i) a section for eye products wherein said eye products are placed into subsections based upon the eye color for which they are color coordinated and the eye products in each eye color subsection are color coordinated with each other; and (ii) a section for lip products wherein said lip products are placed into subsections based upon basic shade and the lip products in each basic shade or shade family subsection are color coordinated with each other; or (iii) combinations thereof.

Optionally, the display configurations mentioned above may additionally contain one or more sections as follows: (iv) a section for suncare products; (v) a section for anti-aging products; (vi) a section for products having a certain desired end benefit; or combinations thereof.

The invention is further directed to a method for enabling the cosmetics shopper to select eye products color coordinated with her eye color comprising providing a cosmetic display containing at least one section for eye products wherein said eye products are placed into subsections based upon the eye color for which they are color coordinated and the eye products in each eye color subsection are color coordinated with each other.

The invention is further directed to a method for enabling the cosmetics shopper to select color coordinated lip products based upon preferred basic shade comprising providing a display where lip products are placed into subsections based upon basic shade such that the shopper can select color coordinated lip products from the section containing the basic shade she most prefers.

The invention is further directed to a method for enabling the cosmetic shopper to purchase products suitable for her skin type and coloring from a display, comprising:

(a) providing a section of the display for face products where such products are placed into subsections according to skin type so that the shopper, after interpreting her skin type, may select face products suitable for her skin type from the subsection of the display corresponding to that skin type,

(b) providing at least one of an additional section, wherein said additional section is selected from: (i) a section for eye products wherein said eye products are placed into subsections based upon the eye color for which they are color coordinated and the products in each eye color subsection are color coordinated with each other; and (ii) a section for lip products wherein said lip products are placed into subsections based upon basic shade and the lip products in each basic shade subsection are color coordinated with each other; or (iii) combinations thereof; wherein the consumer selects eye products based upon her eye color or lip products based upon her preferred basic shade; or both.

Optionally, the method may additionally provide one or more sections as follows: (iv) a section for suncare products; (v) a section for anti-aging products; (vi) a section for products having a certain desired end benefit; or combinations thereof.

### BRIEF DESDRIPTION OF THE DRAWINGS

FIG. 1: illustrates a display, or section that can be inserted into a larger display, in accordance with the invention, containing eye products where at least a portion of the eye products are placed into subsections based upon the eye color with which they are color coordinated. In addition, this display may contain eye products that are placed into subsections based upon desired end benefit, such as eyeliner that is blendable, or mascara that lengthens lashes.

FIG. 2: illustrates a display, or section that can be inserted into a larger display, in accordance with the invention, containing lip products wherein at least a portion of the lip products are placed into subsections based upon the basic shade of the product. The display, or display section, may also contain other lip products that are placed into subsections based upon desired end benefit, such as long wearing, vibrantly colored, or lip care products.

FIG. 3: illustrates a display, or section that can be inserted into a larger display, in accordance with the invention, containing face products, wherein at least a portion of the face products are placed into subsections based upon skin type, e.g. oily, normal/combination, dry, or all skin types. The display or section may also contain additional subsections based upon desired end benefit, such as anti-aging properties, sun care, blushers, bronzers, etc.

FIG. 4: illustrates one preferred embodiment of the cosmetics display wall of the invention, which has sections for face, eye, and lip products and other sections based upon desired end benefit, beauty tools, ancillary products, and the like.

FIG. 5: illustrates the various types of racks that may be used, FIGS. 5A-D and F depicting types of product support members that may comprise such racks.

FIG. 5A: depicts racks in the form of stationary shelves.

FIG. 5B: depicts a hook product support member, which when hung from a planar support forms a rack. This type of rack is often referred to as a “hook and hang” system.

FIG. 5C: depicts a shelf type product support member, which, when hung from a planar support forms a rack.

FIG. 5D: depicts a basket type of product support member which, when attached to a planar wall as depicted in FIG. 6 forms another type of rack.

FIG. 5E: depicts one type of signage that may be used in the display of the invention. A removable card or similar can be slid into the recessed area 5E1 of sign holder and is held by curved edges 5E2.

FIG. 5F: depicts a type of product support member that is often referred to as a “slotted dispenser”. This type of product support member is often used to store and dispense cosmetic products sold in cylindrical cases such as lipsticks, lip glosses, or concealers. The cosmetic products are stacked into the slotted dispenser.

FIG. 6: depicts some of the planar supports, or walls, onto which product support members or racks may be affixed to hold cosmetic products.

FIG. 6A: depicts what is often referred to as a “slat wall”.

FIG. 6B: depicts what is often referred to as a “grid wall”.

### DETAILED DESCRIPTION

Eye Products Display and Method

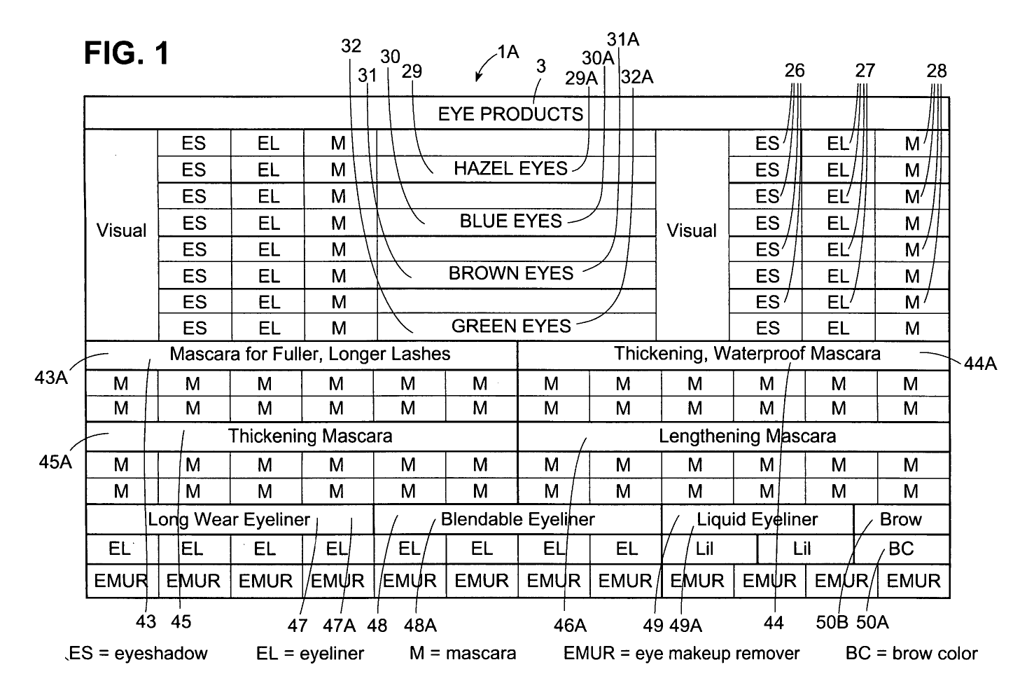

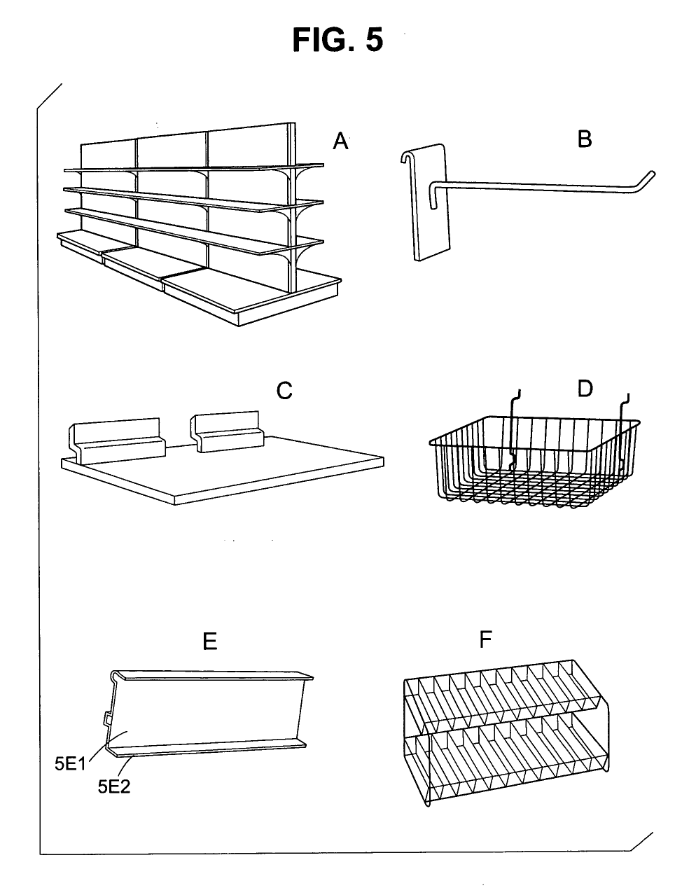

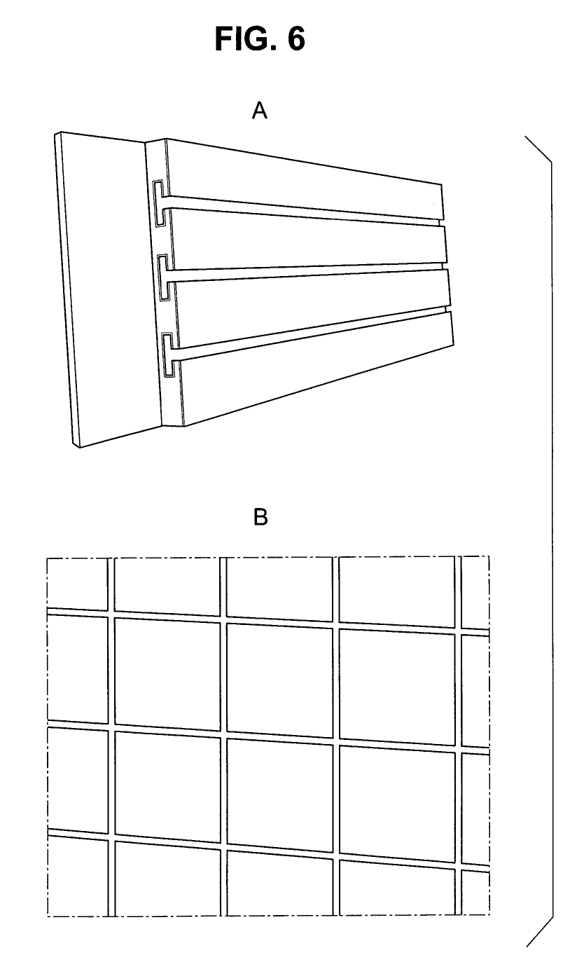

FIG. 1 illustrates the display 1A, or display section, for eye products 3. The display 1A may be a free standing display of eye products 3 only, or if desired, in can be incorporated within a larger display containing other cosmetic products. Typically display 1A contains racks for storing the cosmetic products. Racks are comprised of product support members (FIGS. 5A-D and F), which may or may not be affixed to, or associated with, a planar wall including, but not limited to, those depicted in FIG. 6. Types of product support members include, but are not limited to shelves, baskets, drawers, hooks, slotted dispensers, adjustable shelves, and the like.

The display contains a variety of eye products, including but not limited to, those that are depicted in FIG. 1. The term “eye products” in general, means products that are designed to be applied to the eye area, such as eyeshadow, eyeliner, mascara, eye primer, false eyelashes, and so on.

The eye products 3 include, but are not limited to, eyeshadow 26 (“ES” in FIG. 1), eyeliner 27 (“EL” in FIG. 1), and mascara 28 (“M” in FIG. 1). The eye products 3 may include other types of products suitable for application to the eye area, if desired. The display 1A for eye products 3 is divided into subsections based upon eye color. For example, in the preferred embodiment of the invention, there are subsections are for hazel eyes 29, blue eyes 30, brown eyes 31, and green eyes 32, such sections identified by signage 29A, 30A, 31A, 32A, which identifies the section as containing the products suitable for the particular eye color as identified by signage and found in the section. A display according to the invention may contain fewer or more subsections depending on the preference of the cosmetics manufacturer. Each of sections 29, 30, 31, and 32, identified by signage 29A, 30A, 31A, 32A, denotes to the shopper the various pre-selected eye products most suitable for use with the particular eye color in the section.

Further, some cosmetics manufacturers may elect to have subsections for only blue, brown, or combination eyes (e.g. hazel or green) as depicted in sections 29-32; or some other cosmetics manufacturers may desire to have displays containing more eye color choices such as hazel, blue, brown, green, grey, lavender, and so on.

The eye products 3 are color coordinated so that the eye products 3, such as eyeshadow 26, eyeliner 27, and mascara 28 that are most suited for hazel eyes 29 are found in the subsection for hazel eyes 29 as denoted by signage 29A. Each of the other sections 30A, 31A, 32A is also identified by signage that identifies or further describes the products in each of the corresponding sections.

The eye products 3 such as eyeshadow 26, eyeliner 27, and mascara 28, that are most suitable for blue eyes are found in the subsection for blue eyes 30, which is identified by signage 30A that denotes to the shopper that the eye products in that section are pre-selected for use with blue eyed individuals.

The eye products 3 that are most suitable for brown eyes, including but not limited to eyeshadow 26, eyeliner 27, and mascara 28 are found in the subsection for brown eyes 31, which is identified by signage 31A that denotes to the shopper that the eye products in that section are suitable for brown eyed individuals.

The eye products 3 most suitable for green eyes, are found in the subsection for green eyes 32, which is identified by signage 32A that denotes to the shopper that the eye products in that section are most suitable for green eyed individuals.

The eye products 3 in subsections 29, 30, 31, and 32 have been color coordinated with eye color by the cosmetics manufacturer, who has selected the most complementary colors for each eye color. If desired, consumers shopping in the subsection devoted to her eye color may select from eye products that provide a more subtle “day” look and eye products that provide a more accentuated “night” or “made up” look.

In addition to providing products that are color coordinated with eye color, the products within each subsection are color coordinated with each other. For example, the consumer with hazel eyes can select from products such as eyeshadow, eyeliner, mascara that best match or accentuate her eye color. The products are all color coordinated with each other so they match and provide the best result. A display set up in this manner provides what is referred to as a 1-2-3 approach to purchasing eye products. The consumer shops at the subsection of the display corresponding to her eye color and selects product 1 (the eyeshadow), product 2 (the eyeliner), or product 3 (the. mascara), but preferably will select all of the products. The 1-2-3 approach greatly simplifies shopping for the cosmetics consumer and also is likely to increase product sales. The consumer will likely purchase not only one product, but the other products that are associated with the product she is purchasing because the products have been color coordinated with each other and are a match with her eye color.

This creates an almost foolproof way for the shopper to select eye products 3 that will complement her eye color, and to purchase eye products that are associated with the other product she desires to purchase. There is minimal consumer interpretation because all shoppers are capable of accurately characterizing their eye color.

The eye products display 1A may also contain eye products 3 that are placed into subsections based upon desired end benefit, or products used with eye products, such as eyelash curlers, false lashes, eye makeup removers, and so on. The term “desired end benefit” with respect to eye products means the end benefit the consumer desires when purchasing the eye products. With respect to mascaras, desired end benefits may include lengthening, thickening, waterproof, and so on. By way of example only, if the consumer has identified a need for a product that accentuates her lashes and is waterproof, she clearly desires a mascara where the end benefit is its waterproof property. She then shops at the section of the display that contains mascara products that are identified as having this property.

In the preferred embodiment of the display 1A of FIG. 1, mascaras suitable for all eye colors are placed into subsections based upon end benefits such as fuller, longer lashes 43, thickening and waterproof 44, thickening 45, or lengthening 46. Corresponding signage 43A, 44A, 45A, or 46A denotes the end benefit of the particular products in the section.

Similarly, products such as eyeliner may be placed into subsections based upon desired end benefits such as long wear 47, blendability 48, or liquid liner 49 with corresponding signage 47A, 48A, or 49A denoting the particular type of eyeliner with desired end benefit to facilitate the consumer's shopping experience. Products for the eyebrows, such as brow color 50A, may be placed in a separate subsection 50B in the eye products 3 section.

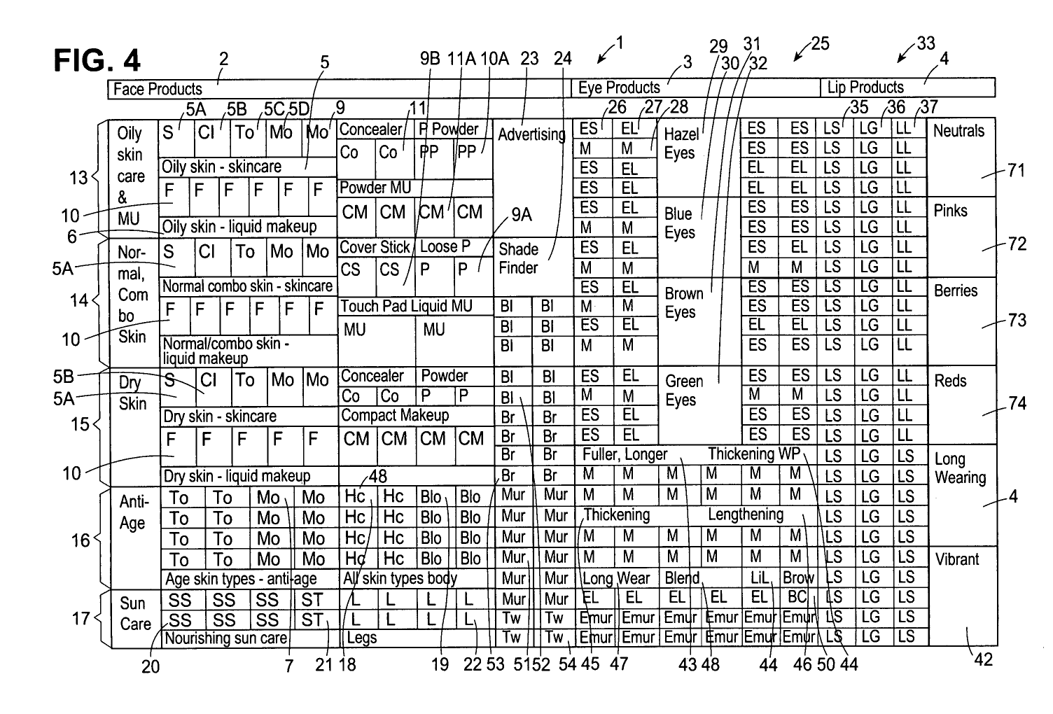

Display 1A may be a separate display in a store, or it may be part of a larger display that contains other cosmetic products for the face or lips, or other ancillary beauty products. For example, the eye products 3 display of FIG. 1 may also form a section of the cosmetics display depicted in FIG. 4. Preferred is where the eye products 3 display of FIG. 1 forms a section of a larger cosmetics display that contains products for the face, lips, and other types of products.

In a more specific embodiment, the invention is directed to a self-service merchandise display for color-cosmetic products that comprises a rack for holding and displaying, in side-by-side relationship, a plurality of different color cosmetic products such as those set forth above. Signage 29A, 30A, 31A, 32A, divides at least a portion of the rack into a plurality of adjacent sections and identifies each section as containing products suitable for an individual with a specific eye color. A first collection of pre-selected eye cosmetics of one type is mounted in a first one of said sections 29. Each of the eye cosmetics within said first collection 29 have been pre-selected for use with the eyes of the color identified by corresponding signage 29A for that particular first section of the rack. A second collection of pre-selected eye cosmetics of the same type as the first collection is mounted in a second one of said sections 30. The eye cosmetics within said second collection have pre-selected for use with eyes of the color identified for that second section of the rack on signage 30A. Most preferably, the only substantial difference between the eye cosmetics in section 29 and section 30 is color, e.g. the eye cosmetics in section 29, suitable for one eye color, will generally have a different color than the eye cosmetics in section 30, which are suitable for another eye color. In general, the second collection contains at least one eye cosmetic that is of a different color from all the eye cosmetics in said first collection.

The display may have two or more sections. Preferably the display contains three to six different sections, all of which contain collections that have been pre-selected for use with eyes of a specific color, e.g. hazel, blue, brown, green, lavender, gray, etc. The colors of the different eye products in the collections are different depending on the color of eyes that they are pre-selected to coordinate with.

In a preferred embodiment of the invention, signage divides at least a portion of the rack into at least three adjacent sections 29, 30, 31, and contains corresponding signage 29A, 30A, 31A, that identifies each of those sections as containing eye products most suitable for use with the eye color denoted on signage, and wherein the display further comprises a third collection of pre-selected eye cosmetics of the same type as the first and second collections, mounted in a third one of said rack sections, wherein each of the eye cosmetics within said third collection has been pre-selected for use with eyes of the color identified for that third section of the rack, and wherein, preferably, the third section contains at least one eye cosmetic that is of a different color from all of the eye cosmetics in said first and second collection.

In such display, for each specific eye cosmetic product that is dispensed from the different sections, there are product support members that are capable of holding one, or a plurality of, units of that specific eye cosmetic product, one behind the other. For example, when the product support members are shelves (FIG. 5A) the eye products in one section are placed on the shelves. When the product support members are hooks (FIG. 5B), the eye products may be found in carded form, e.g. affixed to cards using plastic blisters, where the cards are hung from the hook. Where the product support members are baskets 5D, the eye products may be placed into baskets that are affixed to planar wall (FIG. 5G). The various eyeshadows for each section can be placed into one basket, the eyeliners in another, and the mascaras in a third basket, and so on.

In the most preferred embodiment of the invention, all the colors of the eye cosmetics in the first section or collection 29 are different from the colors of the eye cosmetics in the second section or collection 30, and all of the colors of the eye cosmetics in the third section or collection 31 are different from the colors of the eye cosmetics in the first and second collections 29, 30, respectively. In the case where there are fourth and fifth collections, the eye cosmetics in the fourth collection 32 are different from the colors of the eye cosmetics in the first, second, and third collections, and so on.

Further, the invention as described herein is not limited to eye cosmetics that are dispensed from an actual physical display. Rather, the arrangement of the cosmetics could be made manually by a beauty advisor or sales representative in a home sales setting, in department store set up, or in any other environment. All such arrangements are within the spirit and scope of this invention.

Lip Products Display or Section

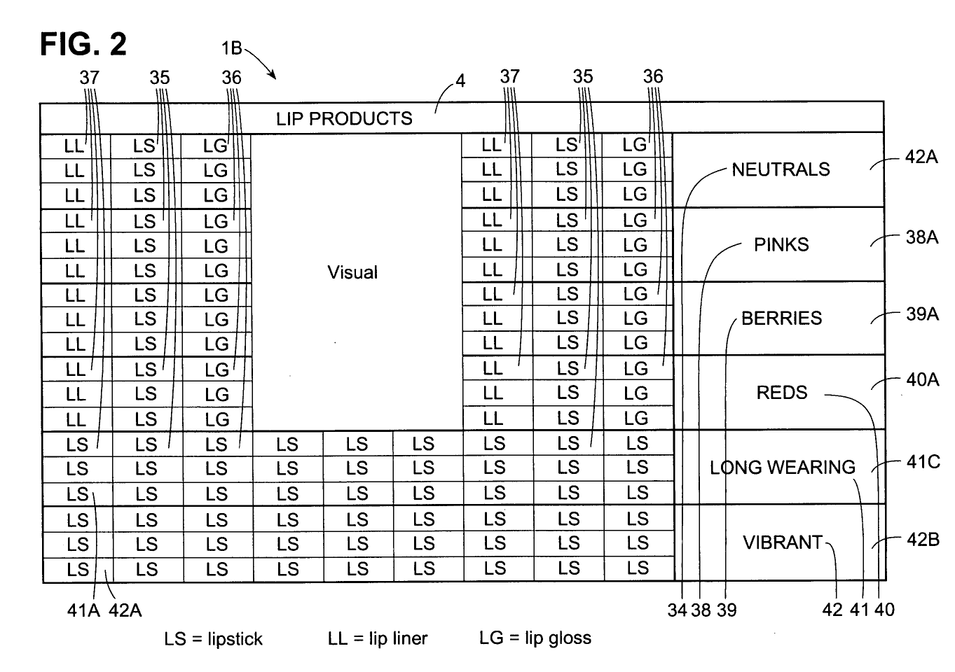

FIG. 2 illustrates a display 1B or section 33 thereof, for lip products 4. The term “lip products” means products that are applied to the lip, such as lipstick, lip gloss, lip liner, lip balm, lip primer, and the like.

Preferably, the lip products 4 are categorized into subsections that reflect their basic shade. The term “basic shade” means general color family. In the preferred embodiment of the invention, the basic shade categories include, or consist of, neutral, pinks, berries, or reds. However, there are other possible categories based upon basic shades, such as red, red/blue, pink, brown, purple, and so on. In this case, the display for lip products 4 contains subsections corresponding to the selected basic shades.

In the preferred embodiment of the invention the subsection dedicated to neutral lip colors (neutrals) 34 contains lip products 4 such as lipliner 37, lipstick 35, or lipgloss 36, and may contain additional lip products. If so, they are in the same general shade family and are color coordinated with the other products present. Similarly, the subsection dedicated to pink-type lip colors (pinks) 38, also contain lip products 4 such as or lipliner 37, lipstick 35, lipgloss 36, and, if desired, other types of lip products that are color coordinated. The subsection dedicated to berry lipcolors (berries) 39 contains lipliner 37, lipstick 35, or lipgloss 36, and other products if desired. The subsection dedicated to red lipcolors (reds) 40 may also contain lipliner 37, lipstick 35, or lipgloss 36, and other products, if desired. In all cases the lip products 4 in each subsection have been color coordinated with each other so that the lipstick 35, lipgloss 36, and lip liner 37 match or complement each other, and if other lip products are present, they color co-ordinate with those already present. If desired, one or more sections of any one or more of the displays may contain visuals, as noted on the Figures. Visuals may contain model photographs, shade suggestions, or other consumer information.

This type of set up for lip products also incorporates the beauty 1-2-3 concept. In particular, the consumer shops at the subsection of the display corresponding to her preferred basic shade, and can select from 1, 2, 3, or more products that are available in her preferred basic shade and which have all been color coordinated with each other. For example, the consumer who prefers neutral lip products will shop in the subsection dedicated to neutral products and may select from lipstick (product 1), lipliner, (product 2), or lip gloss (product 3), preferably purchasing all three products.

The shopper does not need to worry about matching colors for the various lip products. Instead, the cosmetics manufacturer has already pre-matched the various types of lip products 4 in the various subsections 34, 38, 39, and 40, and, essentially, done all of the shopper's work for her.

In a more specific embodiment, the invention is directed to a self-service merchandise display for color cosmetic products comprising a rack for holding and displaying color cosmetic products, such as lip products. Suitable racks include those set forth in FIGS. 5A-F. Such racks generally comprise product support members, preferably affixed to a planar wall as depicted in FIG. 6. Such racks hold and display a plurality of such color cosmetic products such as lipsticks. Said racks are divided into sections, e.g. 34, 38, 39, 40, 41, 42. Each of said sections is identified by signage 34A, 38A, 39A, 50A, 41A, and 42A. Such signage divides at least a portion of the rack into a plurality of adjacent sections and identifies each of those sections by a different group identifying color that is generally representative of a set of more specific colors that fall within the generally identified color.

For example, in the section identified by signage 40A indicating “red”, various color cosmetic products having principally a red shade will be found. In another example, in the section identified by signage 39A indicating “berries”, various color cosmetic products having principally a berry shade (a shade that has a depth and hue similar to berries such as strawberries, raspberries, or blueberries); and so on.

The display further comprises a second collection of pre-selected lip cosmetics, of the same general type as the first collection and mounted on racks in one in one of the rack sections. The only difference between the cosmetics in the first and second collections or sections is their color, with each of the specific lip products in a particular section being generally differently colored than each of the specific lip products in another particular lip section. Corresponding signage 42A, 38A, 39A, 40A, denotes the different general color categories of the different collections; with the specific lip products in the collections being color variations on the different general color category denoted by signage.

The display 1B may also contain one or more subsections for other types of lip products 4, including but not limited to those have desired end benefits such as long wear, transfer resistance, vibrant shades, lip balms, and so on. Signage denoting the other end benefit properties may also identify the sections for the shopper's convenience.

For example, subsection 41 in display 1B contains long wearing lipcolor and contains lipsticks 41A and, if desired, other types of lip products such as liners, glosses, and so on. Section 41 of the display is identified by signage 41C which describes the end benefit or category type for the shopper. Similarly, with respect to section 42, signage 42B describes the section so the shopper will understand what products are offered there. For example, lip products 4 such as lipsticks 42A that have other special properties such as vibrant shades 42 or therapeutic properties, or the like, may be found in such sections.

The various types of racks and product support members suitable for use in this type of section are as set forth in the section above with respect to eye products. Specifically, suitable product support members for such lip products include those set forth in Sections 5A-D and F, such as hooks, shelves, adjustable shelves, baskets, slotted dispensers and so on. The product support members are preferably affixed to a planar wall (FIG. 6), and products are then affixed to the product support members. FIG. 5E depicts one type of holder for signage. In particular, the signage may comprise a holder where a card or tag can be removably inserted into the holder.

The lip products 4 display 1B may be separate, or it may be part of a larger cosmetics display that contains sections for eye, face, or other types of beauty products. Preferred is where the display 1B for lip products 4 is a section in a larger cosmetics display containing other products, such as depicted in FIG. 4.

As with respect to the eye products, the arrangement of lip products as noted herein is not limited to actual physical displays in a retail environment. Rather, the lip products may be arranged in such a manner manually by a beauty advisor or sales rep in a department store or at-home sales environment, or in any other sales environment. Such arrangements are within the spirit and scope of this invention.

Face Products Display or Section

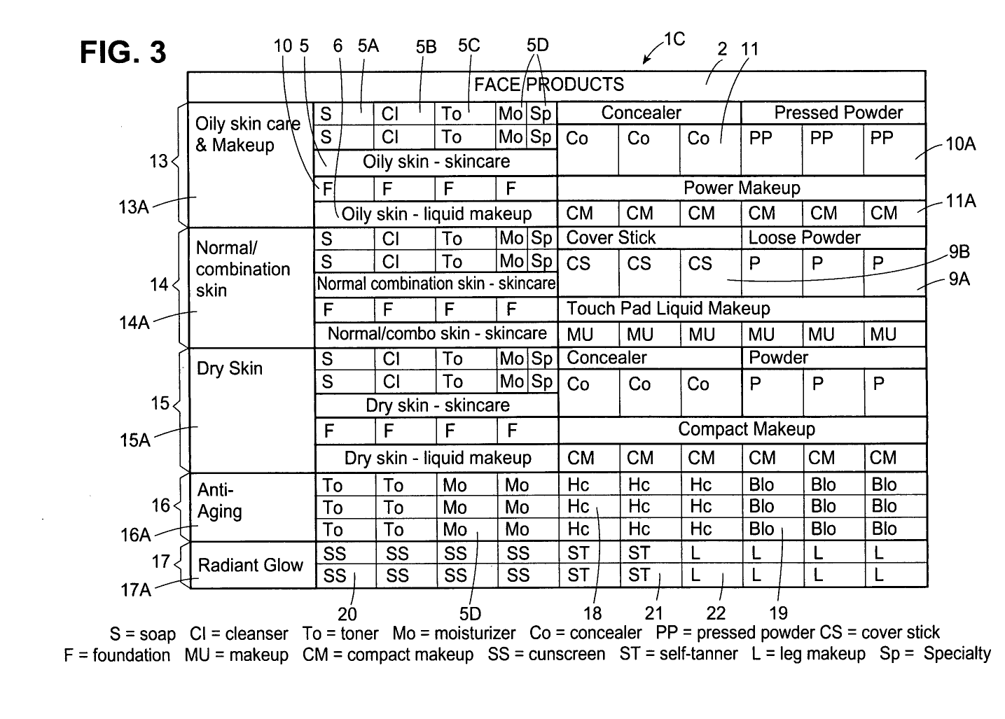

FIG. 3 depicts a display 1C for face products 2, which may be free standing or a section of a larger display containing other types of cosmetic products. The term “face products” means skin treatment products 5 and makeup products 6. Skin treatment products 5 include, but are not limited to, products such as facial soap 5A (“S” in FIG. 3), cleanser 5B (“Cl” in FIG. 3), toner 5C (“To” in FIG. 3), or facial moisturizer 5D (“Mo” in FIG. 3). Makeup products 6 means makeup products for the face, such as liquid or cream foundation makeup 10 (“F” in FIG. 3), concealer 11 (“Co” in FIG. 3), pressed powder 10A (“PP” in FIG. 3), compact foundation makeup 11A (“CM” in FIG. 3), powder 9A (“P” in FIG. 3), and a concealer (or cover) stick 9B (“CS” in FIG. 3).

The face products 2 are placed into subsections 13, 14, and 15, based upon whether they are suitable for “oily” 13,. “normal/combination” 14, or “dry” 15 skin. The cosmetics shopper interprets her skin type, then selects from the products in the subsection corresponding to her skin type. As noted above the relevant subsection contains both skin treatment products and color cosmetic products.

If desired, the display 1 may also contain additional sections for other types of skin care products such as those for anti-aging skin care 16, suncare 17, and the like. Typical products that may be found in the anti-aging skin care 16 section include, but are not limited to, facial moisturizers (“Mo” in FIG. 1), or hand creams or lotions 18 (“HC” in FIG. 1), or body lotions 19 (“BLo” in FIG. 1) all of which may have firming, toning, anti-pollution, or other beneficial properties. Typical products that may be found in the sun care section 17 include sunscreen lotions 20 (“SS” in FIG. 1) self-tanners 21 (“ST” in FIG. 1), or leg bronzers or makeup 22 (“L” in FIG. 1).

More specifically, the face products may be sold on racks comprised of product support members, preferably affixed to a planar wall. Examples of suitable product support members include those set forth in FIGS. 5A-F. Corresponding signage identifies the face products in each of the sections, denoting to the consumer what the end benefit of the products in the sections are. For example in section 13, face products for oily skin care and makeup are placed into a section. Signage 13A identifies the face products to the consumer, denoting the particular end benefit. In section 14 products for normal/combination skin are found, identified by signage 14A denoting the products as having that end benefit. Similarly, section 15 contains face products for dry skin, denoted with signage 15A that identifies the products as such; and so on with respect to anti-aging products and sun care products.

The various face products are pre-selected to work together. For example, the soap, cleanser, toner, and foundation makeup are all designed for a certain skin type such that everything the consumer puts on her face is particularly designed for her skin.

The face products 2 may also be sold as part of the beauty 1-2-3 concept discussed above with respect to the eye products and the lip products. In particular, the consumer desiring to purchase face products 2 will shop at the display 1C or section of the display dedicated to face products 2. The consumer identifies her skin type as oily, normal/combination, or dry, then shops at the subsection corresponding to her interpreted skin type. The consumer then selects the suitable skin treatment products such as soap or cleanser (product 1), toner (product 2), or moisturizier (product 3). Preferred is where the skin treatment products are actually numbered “1”, “2”, and “3”, further simplifying the use for the consumer. One type of 1-2-3 arrangement is where the facial soap and/or cleanser comprises step 1, the toner comprises step 2, and the moisturizer step 3 in the skin care regime. There may be an additional “+” category referred to as “specialty” which generally means a specialty skin product such as a serum, under eye cream, and so on.

The 1-2-3 strategy also works with the makeup products. The consumer purchases concealer (1), foundation makeup or compact makeup (2), and either pressed or loose powder (3); preferably purchasing more than one or all of the products in the line suitable for her skin type.

The section of the display 1C dedicated to face products 2 may contain subsections other than those devoted to anti-aging products or sun products. Examples of such other types of subsections include those containing ancillary beauty products such as makeup removers, cleansing towlettes, blemish spot treatment products, and so on.

The arrangement of cosmetics for the face is not limited to displays in a retail environment. Rather, the invention includes manual arrangement of such face cosmetics, such as found in an at-home or informal sales environment, department store, etc. Such manual or alternate arrangements are within the spirit and scope of this invention.

Full Cosmetics Display

In the most preferred embodiment of the invention, the display contains a full array of cosmetic products, containing a subsection devoted to eye products, a subsection devoted to lip products, and a subsection devoted to face products as described above.

FIG. 4 depicts the preferred embodiment of the cosmetics display i according to the invention. The display 1 contains sections including those for eye products 3, lip products 4, and face products 2 as described above. In addition, the display 1 contains one or more sections devoted to educating the shopper about various other matters, or for showing model photographs 23. For example, a section 24 may be dedicated to assisting the shopper in finding the correct shade, which contains various shade swatches that approximate the foundation makeup 10 shades that are available for purchase in the face products 2 section. The shopper can match her skin color with the shade swatch that is closest to her skin color, then select the foundation makeup 10 shade from the face products 2 section that matches her skin color. Section 24 may also contain a tutorial that instructs the shopper that she should shop based upon whether the item she is looking for is for her face, eyes, or lips.

In addition, the display 1 may contain sections for other types of products including but not limited to ancillary beauty products such as makeup removers 51, blusher 52, bronzer 53, and towlettes 54, eyelash curlers, and so on. These products may be placed in the relevant section corresponding to the section of the body being treated, or may be otherwise categorized in other ways that may assist the consumer in the shopping experience.

In addition, the 1-2-3 shopping experience for face, eye, and lip products, facilitates the consumer's ability to select coordinated products for the face, eyes, and lips based upon the 1-2-3 strategy discussed above with respect to each category, and provides an impetus for increasing sales of products. Accordingly, the consumer can purchase eye products 1, 2, 3, which are coordinated with her eye color and color coordinated with each other; lip products 1, 2, 3, that are in her basic shade preference and color coordinated with each other 1, 2, 3; and face products 1, 2, 3 that are suitable for her skin type and include skin treatment and basic makeup. The 1-2-3 set up is designed to induce the consumer to purchase more products than she would otherwise purchase knowing that such products are coordinated. However, the consumer may elect to purchase only one or two products from each of the categories.

The arrangement of lip, eye, and face cosmetics noted herein is not limited to retail display environments. Rather, the spirit and scope of the invention includes manual arrangements such as may be found in an at-home or informal setting, or in a department store setting, for example.

In general, the display and method of the invention enables the cosmetics shopper to purchase a variety of products that are suitable for her skin type and coloring based upon minimal consumer interpretation. After the consumer makes certain very simple interpretations (e.g. skin type dry, normal/combination, or oily; eye color; or lip basic shade preference) she selects the products in the subsections corresponding to her interpreted type, where such products have been color coordinated or otherwise matched with her parameters. This virtually eliminates most of the guess work involved in selecting cosmetics, with the end result being a consumer who purchases products that she is ultimately happy with.

The display and method of the invention provide a more foolproof way for the cosmetics shopper to purchase skin care and color cosmetic products that are exactly suitable for her skin type and coloring, minimizing the chance that the customer purchases a litany of products that she ultimately is not satisfied with.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. A self-service merchandise display for color cosmetic products comprising:
a) a rack for holding and displaying a plurality of color cosmetic products;
b) signage that divides at least a portion of the rack into a plurality of adjacent sections and identifies each of those sections by a different group-identifying color that is representative of a set of specific related colors within that group-identifying color;
c) a first collection of pre-selected lip cosmetics mounted in a first one of said rack sections, wherein each of the cosmetics within said first collection is of a color that is within the set that is represented by the particular group-identifying color that the signage designates for that first section of the rack; and
d) a second collection of pre-selected lip cosmetics, of the same type as the first collection, mounted in a second one of said rack sections, wherein (i) the only substantial difference between the cosmetics in the first collection and the cosmetics in the second collection is their color and (ii) each of the cosmetics within the second collection is of a color that is within the set that is represented by the particular group-identifying color that the signage designates for that second section of the rack.

2. The display of claim 1, wherein the lip cosmetics in both the first and second collections are selected from the group consisting of lipstick, lipgloss, and lipliner.

3. The display of claim 2, wherein the signage divides at least a portion of the rack into at least three adjacent sections and identifies each of those sections by a different group-identifying color that is representative of a set of related colors within that group-identifying color, and wherein the display further comprises:
e) a third collection of pre-selected lip cosmetics of the same type as the first and second collections, mounted in a third one of said rack sections, wherein (i) the only substantial difference between the lip cosmetics in said third collection and the lip cosmetics in said first and second collections is their color and (ii) each of the lip cosmetics within said third collection is of a color that is within the set that is represented by the particular group-identifying color that the signage designates for that third section of the rack.

4. The display of claim 3, wherein for each specific lip cosmetic product that is mounted in said at-least-three rack sections there is at least one mounting means dedicated solely to that product, which mounting means is capable of holding a plurality of units of that specific lip cosmetic product, one behind the other.

5. The display of claim 4, wherein all of the colors of the cosmetics in the first collection are different from the colors of the cosmetics in the second collection, and all of the colors of the cosmetics in the third collection are different form the colors of the cosmetics in the first and second collections.

6. A self-service merchandise display for color-cosmetic products comprising:
a) a rack for holding and displaying, in side-by-side relationship, a plurality of different color cosmetic products;
b) signage that divides at least a portion of the rack into a plurality of adjacent sections and identifies each section by a different eye color;
c) a first collection of pre-selected eye cosmetics of one type mounted in a first one of said sections, wherein (i) the only substantial difference between the eye cosmetics within said first collection is their color and (ii) each of the eye cosmetics within said first collection have been pre-selected for use with the eyes of the color identified for that first section of the rack; and
d) a second collection of pre-selected eye cosmetics of the same type as the first collection mounted in a second one of said sections, wherein (i) the only substantial difference between the eye cosmetics within said second collection is their color, (ii) all of the eye cosmetics within said second collection have been pre-selected for use with eyes of the color identified for that second section of the rack, and (iii) said second collection contains at least one eye cosmetic that is of a different color from all the eye cosmetics in said first collection.

7. The display of claim 6, wherein the type of eye cosmetic that forms both the first and second collections is selected from the group consisting of eyeshadow, eyeliner, and mascara.

8. The display of claim 7, wherein the signage divides at least a portion of the rack into at least three adjacent sections and identifies each of those sections by a different eye color, and wherein the display further comprises
e) a third collection of pre-selected eye cosmetics of the same type as the first and second collections, mounted in a third one of said rack sections, wherein (i) the only substantial difference between the eye cosmetics in said third collection and the eye cosmetics in said first and second collections is their color and (ii) each of the eye cosmetics within said third collection has been pre-selected for use with eyes of the color identified for that third section of the rack, and (iii) said third section contains at least one eye cosmetic that is of a different color from all of the eye cosmetics in said first and second collection.

9. The display of claim 8, wherein for each specific eye cosmetic product that is mounted in said at-least-three rack sections there is at least one mounting means dedicated solely to that product, which mounting means is capable of holding a plurality of units of that specific eye cosmetic product, one behind the other.

10. The display of claim 9, wherein all of the colors of the eye cosmetics in the first collection are different from the colors of the eye cosmetics in the second collection, and all of the colors of the eye cosmetics in the third collection are different from the colors of the eye cosmetics in the first and second collections.

11. A cosmetic display for eye products wherein said eye products are placed into subsections based upon the eye color for which they are color coordinated, and the products in each subsection corresponding to a specific eye color are color coordinated with each other.

12. The display of claim 11 wherein the eye products are selected from eyeshadow, mascara, eyeliner, or combinations thereof.

13. The display of claim 11 wherein the eye color subsections are for hazel, blue, brown, or green eyes.

14. The display of claim 13 wherein each eye color subsection contains at least three products that are color coordinated with each other.

15. The display of claim 14 wherein the three products are eyeshadow, eyeliner, and mascara.

16. The display of claim 11 additionally comprising one or more additional sections selected from (i) a section for face products wherein the face products are placed into subsections based upon the skin type for which they are most suitable, (ii) a section for lip products wherein the lip products are placed into subsections based upon basic shade, (iii) a section for suncare products, (iv) a section for anti-aging products, (v) a section for products having a certain end benefit; or (vi) combinations thereof.

17. A cosmetic display for lip products wherein such lip products are placed into subsections based upon basic shade, and each subsection corresponding to a basic shade has lip products that are color coordinated with each other.

18. The display of claim 17 wherein the basic shades are neutral, pink, berry, or red.

19. The display of claim 17 wherein the lip products are selected from lipstick, lip gloss, and lip liner.

20. The display of claim 17 containing at least one additional section selected from: (i) a section for face products wherein such face products are placed into subsections based upon the skin type for which they are most suitable, (ii) a section for eye products wherein the eye products are placed into subsections based upon the eye color for which they are color coordinated; (iii) a section for anti-aging products, (iv) a section for sun care products, (v) a section for products having a desired end benefit; or (vi) combinations thereof.

21. The display of claim 20 wherein the face products are skin treatment products, face makeup products, or combinations thereof.

22. The display of claim 21 wherein the skin treatment products include soap, cleanser, toner, moisturizer, or combinations thereof.

23. The display of claim 21 wherein the face makeup products include foundation, concealer, compact makeup, pressed powder, loose powder, primer, blush, or combinations thereof.

24. The display of claim 20 wherein the face products are placed into subsections based upon whether they are suitable for oily, normal/combination, or dry skin.

25. The display of claim 17 further comprising a section for face products, a section for eye products, or combinations thereof.

26. The display of claim 20 additionally comprising one or more additional sections selected from: (i) suncare products, (ii) anti-aging products, (iii) products with a desired end benefit; or (iv) combinations thereof.

27. A cosmetic display comprising, in combination
(a) a first section containing face products wherein such face products are placed into subsections based upon the skin type for which they are most suitable; and
(b) at least one of an additional section, wherein said additional section is selected from:
(i) a section for eye products wherein said eye products are placed into subsections based upon the eye color for which they are color coordinated and the eye products in each eye color subsection are color coordinated with each other; and,
(ii) a section for lip products wherein said lip products are placed into subsections based upon basic shade, and the lip products in each basic shade subsection are color coordinated with each other; or (iii) combinations thereof.

28. The display of claim 27 where the subsections into which the face products are placed are based upon whether they are most suitable for dry, normal/combination, or oily skin.

29. The display of claim 28 wherein the face products are skin treatment products and face makeup products.

30. The display of claim 29 wherein the skin treatment products include soap, cleanser, toner, moisturizer, or combinations thereof.

31. The display of claim 29 wherein the face makeup products include foundation makeup, primer, concealer, or combinations thereof.

32. The display of claim 27 wherein the eye products are eyeshadow, eyeliner, or mascara.

33. The display of claim 27 wherein the lip products include lip gloss, lip liner, or lipstick.

34. The display of claim 27 wherein the lip product basic shade subsections are neutral, pink, berry, or red.

35. The display of claim 27 wherein the subsections based upon skin type are color coded so that all of the products in the same subsection have the same color identifier.

36. The display of claim 27 wherein the sections for face products, eye products, and lip products each have a separate color scheme.

37. The display of claim 17 additionally containing one or more sections selected from: (iv) a section for suncare products; (v) a section for anti-aging products; (vi) a section for products having a certain desired end benefit; or (vii); or combinations thereof.

38. The display of claim 37 wherein the suncare products are sunscreens, self-tanners, bronzers, or combinations thereof.

39. The display of claim 37 wherein the anti-aging products are cleanser, toner, moisturizer, or combinations thereof.

40. The display of claim 37 wherein the section containing products having a certain desired end benefit includes a subsection for mascara products where the desired end benefits are selected from: (i) fuller and longer lashes, (ii) thicker lashes, (iii) longer lashes, (iv) waterproof; or (v) combinations thereof.

41. The display of claim 37 wherein the section containing products having a certain desired end benefit includes a subsection for lip products where the desired end benefit is selected from: (i) long wearing, or (ii) vibrant shades.

42. The display of claim 37 wherein the section containing products having a certain desired end benefit includes a subsection for eye liner products having the desired end benefit selected from:
(i) long wear, (ii) blendable, or (iii) liquid liner.

43. The display of claim 27 additionally containing one or more sections with ancillary beauty products such as makeup remover, towlettes, eye makeup remover, or combinations thereof.

44. A method for inducing a cosmetics shopper to purchase additional eye products other than the eye product she is shopping for by providing a display for eye products wherein at least some of the eye products in the display are placed into subsections based upon eye color, and wherein the eye products in each eye color subsection are color coordinated with each other.

45. The method of claim 44 wherein the eye color subsections are for hazel, brown, blue, or green eyes.

46. The method of claim 45 wherein the eye products in each eye color subsection are eyeshadow, eyeliner, or mascara.

47. A method for inducing a consumer to purchase additional lip products in addition to the lip products she is shopping for by providing a display for lip products wherein at least some of the lip products in the display are placed into subsections based upon basic shade and the lip products in each basic shade subsection are color coordinated with each other.

48. The method of claim 47 wherein the basic shade subsections are for neutral, red, berry, or pink.

49. The method of claim 47 wherein the lip products include lipstick, lip liner, or lip gloss.

50. A method for enabling the cosmetic shopper to select eye products color coordinated with her eye color comprising providing a display containing subsections wherein said eye products are placed into subsections based upon the eye color for which they are color coordinated, and the products in each subsection corresponding to a specific eye color are color coordinated with each other.

51. The method of claim 50 wherein the eye color subsections are blue, green, hazel, or brown eyes.

52. The method of claim 51 wherein the eye products are mascara, eyeliner, or eyeshadow.

53. A method for enabling the cosmetic shopper to select lip products that are in her preferred basic shade and are color coordinated with each other comprising providing a display containing subsections wherein said lip products are placed into subsections based upon basic shade and the lip products in each subsection are color coordinated with each other.

54. The method of claim 53 wherein the basic shade subsections are neutral, pink, berry, or red.

55. The method of claim 54 wherein the lip products are lip liner, lip gloss, or lipstick.

56. A method for enabling the cosmetic shopper to purchase products suitable for her skin type and coloring, comprising:
(a) providing a section of the display for face products where such products are placed into subsections according to skin type so that the shopper, after interpreting her skin type, may select face products suitable for her skin type from the subsection of the display corresponding to that skin type,
(b) providing at least one of an additional section, wherein said additional section is selected from: (i) a section for eye products wherein said eye products are placed into subsections based upon the eye color for which they are color coordinated and the eye products in each subsection are color coordinated with each other; and (ii) a section for lip products wherein said lip products are placed into subsections based upon basic shade and the lip products in each subsection are color coordinated with each other; or (iii) combinations thereof; wherein the consumer selects eye products based upon her eye color or lip products based upon her preferred basic shade; or both.

58. The method of claim 57 wherein the skin type subsections for the face products are oily, normal/combination, or dry.

59. The method of claim 58 wherein the face products are skin treatment products or face makeup products.

60. The method of claim 59 wherein the skin treatment products are selected from soap, cleanser, toner, moisturizer, or combinations thereof.

61. The method of claim 59 wherein the face makeup products include foundation makeup, primer, concealer, or blush.

62. The method of claim 59 wherein the eye color subsections are hazel, blue, brown, or green.

63. The method of claim 59 wherein the eye products include eyeshadow, eyeliner, or mascara.

64. The method of claim 59 wherein the basic shade subsections are neutral, pink, berry, or red.

65. The method of claim 59 wherein the section of the display for lip products has an additional subsection for longwearing lipcolor.

66. The method of claim 59 additionally providing one or more sections as follows: (iv) a section for suncare products; (v) a section for anti-aging products; (vi) a section for products having a certain desired end benefit; or (vii); or combinations thereof.

67. The method of claim 66 wherein the suncare products are selected from sunscreen, self-tanner, leg makeup, or combinations thereof; and the anti-aging products are selected from toner, moisturizer, hand cream, body lotion, or combinations thereof.
